(19) United States
(12) Patent Application Publication
(10) Pub. No.: US 2025/0372739 A1
(43) Pub. Date: Dec. 4, 2025

(54) UEGO CONTROLLED THERMAL-CHEMICAL TREATMENT METHOD FOR LI-ION BATTERY RECYCLING

(71) Applicant: Ford Global Technologies, LLC, Dearborn, MI (US)

(72) Inventors: Eva Thanasiu, Trenton, MI (US); Renata Michaela Arsenault, Plymouth, MI (US); Jacqueline A. Lymburner, Carleton, MI (US); Mark John Jagner, Ypsilanti, MI (US); David Bilby, Royal Oak, MI (US); Andrew Gregory Getsoian, Canton, MI (US); Giovanni Cavataio, Dearborn, MI (US); Christine Kay Lambert, Dearborn, MI (US)

(73) Assignee: Ford Global Technologies, LLC, Dearborn, MI (US)

(21) Appl. No.: 18/678,499

(22) Filed: May 30, 2024

(51) Int. Cl. H01M 10/54; C22B 7/00; C22B 26/12

(52) U.S. Cl. CPC H01M 10/54; C22B 7/001; C22B 7/006; C22B 26/12

(57) ABSTRACT

A method of extracting lithium from black mass produced by battery recycling includes analyzing the black mass to determine a type of lithium entrapment, quantifying a carbon content of the black mass, adding oxidizing or reducing reagents based on the type of lithium entrapment, monitoring completion of oxidation or reduction with at least one oxygen sensor providing a delta lambda value, and extracting lithium from the black mass with a solvent.

### FIELD

The present disclosure relates to lithium-ion batteries and in particular to methods of recycling lithium-ion batteries.

### BACKGROUND

The statements in this section merely provide background information related to the present disclosure and may not constitute prior art.

Lithium-ion batteries are being used in increasing quantities, owing in part to the developing electric automobile industry. However, these batteries have a limited lifespan.

At the end of life, the battery still contains valuable resources, including lithium. A typical lithium-ion battery contains negative electrode containing mainly graphite and a positive electrode containing a variety of transition metal oxides including LiCoO₂, LiNiₓCo_{y}Mn_{z}O₂, (where x+y+z=1), LiMn₂O₄, or other lithium transition metal oxides (LTMOs). Extracting lithium and other metals from expired batteries provides environmental and economic benefits.

Extraction first requires pretreatment, separation, and concentration of pulverized electrode materials into an intermediate component called black mass. Typically, the black mass is then put through complex multi-unit hydrometallurgical processing involving acid leaching, purification, separation, and recovery of the valuable metals. Lithium recovery is often one of the last steps of this process which can lead to relatively poor recovery as lithium may be lost during various steps in the process. Up-front lithium recovery methods without or preceding acid leaching may be useful to recover lithium with greater efficiency.

The present disclosure addresses challenges related to lithium extraction from batteries.

### SUMMARY

This section provides a general summary of the disclosure and is not a comprehensive disclosure of its full scope or all of its features.

In one form of the present disclosure, a method of extracting lithium from black mass produced by battery recycling includes analyzing the black mass to determine a type of lithium entrapment; quantifying a carbon content of the black mass in an excess oxygen environment; adding oxidizing or reducing reagents based on the type of lithium entrapment; monitoring completion of oxidation or reduction with at least one oxygen sensor, the oxygen sensor providing a delta lambda value; and extracting lithium from the black mass with a solvent.

In variations of this method, which may be implemented individually or in any combination: the method further includes utilizing the carbon content to reduce transition metal oxides until a target exhaust lambda value is reached; the target exhaust lambda value is an exhaust lambda value equal to 1; the oxidation or reduction are completed when the delta lambda value approaches 0; reduction is performed at a temperature between about 600C and 900° C.; the reducing reagent is at least one of carbon monoxide and hydrogen gas; the carbon is quantified with the oxygen sensor in an environment of excess oxygen; and the black mass is analyzed by x-ray diffraction.

According to another form of the present disclosure, a method of extracting lithium from black mass produced by battery recycling includes analyzing the black mass to determine a type of lithium entrapment; quantifying a carbon content of the black mass in an excess oxygen environment; if lithium-intercalated graphite is present, oxidating the black mass with excess oxygen until a delta lambda value approaches 0; if transition metal oxides are present, utilizing the carbon to reduce transition metal oxides until a target lambda value is reached; adding reductant gases to further reduce the transition metal oxides until the delta lambda value approaches 0; extracting lithium from the black mass with a solvent.

In variations of this method, which may be implemented individually or in any combination: the target exhaust lambda value is an exhaust lambda value equal to 1; reduction is performed at a temperature between about 600° C. and 900° C.; the reducing reagent is at least one of carbon monoxide and hydrogen gas; the carbon is quantified with at least one oxygen sensor in an environment of excess oxygen; the black mass is analyzed by x-ray diffraction; and the delta lambda value is produced by at least one UEGO sensor.

In yet another form of the present disclosure, a method of extracting lithium from black mass produced by battery recycling includes analyzing the black mass by x-ray diffraction to determine a type of lithium entrapment; quantifying a carbon content of the black mass in an excess oxygen environment using at least one UEGO sensor; if lithium-intercalated graphite is present, oxidizing the black mass and monitoring completion of oxidation with the at least one UEGO sensor; if transition metal oxides are present, reducing transition metal oxides in the black mass and monitoring completion of reduction with the at least one UEGO sensor; and extracting lithium from the black mass with a solvent.

In variations of this method, which may be implemented individually or in any combination: a delta lambda value is produced by the at least one UEGO sensor; the oxidation is completed when the delta lambda value approaches 0; the reduction is completed when the delta lambda value approaches 0; and the reducing reagent is at least one of carbon monoxide and hydrogen gas.

Further areas of applicability will become apparent from the description provided herein. It should be understood that the description and specific examples are intended for purposes of illustration only and are not intended to limit the scope of the present disclosure.

### BRIEF DESCRIPTION OF DRAWINGS

In order that the disclosure may be well understood, there will now be described various forms thereof, given by way of example, reference being made to the accompanying drawings, in which:

FIG. 1 is a diagram of a system for performing extraction methods according to the present disclosure;

FIG. 2 is a flowchart illustrating a method of extract lithium from black mass, according to the present disclosure;

FIG. 3 is a chart showing x-ray diffraction results for a black mass sample, according to one form of the present disclosure;

FIG. 4 is a chart showing the carbon fraction of black mass vs temperature determined by a UEGO sensor and an FTIR sensor according to the present disclosure;

FIG. 5 is a chart showing the calculated carbon portion of several black mass samples according to the present disclosure;

FIG. 6 is a chart illustrating a ramp up process for an oxidation reaction according to the present disclosure;

FIG. 7 is a chart illustrating an oxidation reaction process according to the present disclosure;

FIG. 8 is a chart illustrating the reaction thermodynamics of a carbon reduction of transition metal oxides according to the present disclosure;

FIG. 9 is a chart illustrating the reaction thermodynamics of a carbon monoxide reduction of transition metal oxides according to the present disclosure;

FIG. 10 is a chart illustrating a carbothermal reduction reaction according to the present disclosure;

FIG. 11 is a chart illustrating a gas phase reduction reaction according to the present disclosure;

FIG. 12 is a chart showing exemplary compositions of a black mass sample through the process according to the present disclosure; and

FIG. 13 is a chart showing the amount of lithium extracted from black mass vs the lithium containing metal oxides.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

As discussed above, lithium recovery begins with black mass. Because black mass may incorporate recycled batteries from a variety of sources, it is not possible to know the composition of a particular batch without testing. Soluble forms of lithium such as LiF and Li₂CO₃ may be readily extracted from the black mass. However, lithium may be entrapped in the form of a lithium-intercalated graphite matrix or in lithium-transition metal oxides (Li-TMO). It is necessary to break down the graphite and/or convert the metal oxides to promote the release of entrapped lithium and formation of soluble lithium compounds.

If the black mass is heat treated with an insufficient amount of reagent a portion of the lithium may not dissolve in a solvent, decreasing the recovery efficiency. On the other hand, if the black mass is treated with excess reagents beyond what is necessary to release the lithium, energy and reagents are wasted. The present disclosure discusses methods of identifying what process is required and monitoring completion of the process.

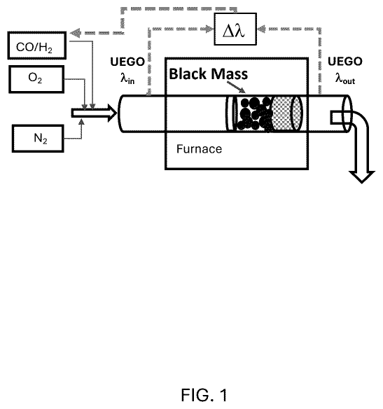

Referring to FIG. 1, a system for use in the method of the present disclosure is shown. The black mass is placed in a furnace which has gas inlets and an exhaust. An oxygen sensor is placed on the exhaust. In one form, an additional oxygen sensor may be placed on the inlet. As shown, the oxygen sensors are universal exhaust gas oxygen (UEGO) sensors; however, other types of oxygen sensors such as heated exhaust gas oxygen (HEGO) sensors may be used.

The oxygen sensors provide a lambda value, which indicates the proportion of oxygen in the gas stream. A lean gas stream has excess oxygen and has an absolute lambda value of greater than 1. If the gas stream is neutral, the oxygen sensor will provide an absolute lambda value of 1. A reducing environment is indicated by an absolute lambda value of less than 1.

A delta lambda value is calculated by comparing an exhaust lambda value and an inlet lambda value. In one form, the inlet oxygen sensor is optional, as the inlet lambda value is a known quantity regardless of the feed gas and therefore the delta lambda can be calculated. If a reaction is occurring in the furnace that results in less or more oxygen in the exhaust stream, the delta lambda value will be greater than zero or less than zero respectively. As any reaction in the furnace approaches completion, the delta lambda value approaches zero. For the purposes of the present disclosure, approaching zero should be interpreted to mean that the delta lambda value is between −0.001 and 0.001 (the absolute value of the delta lambda value is less than 0.001).

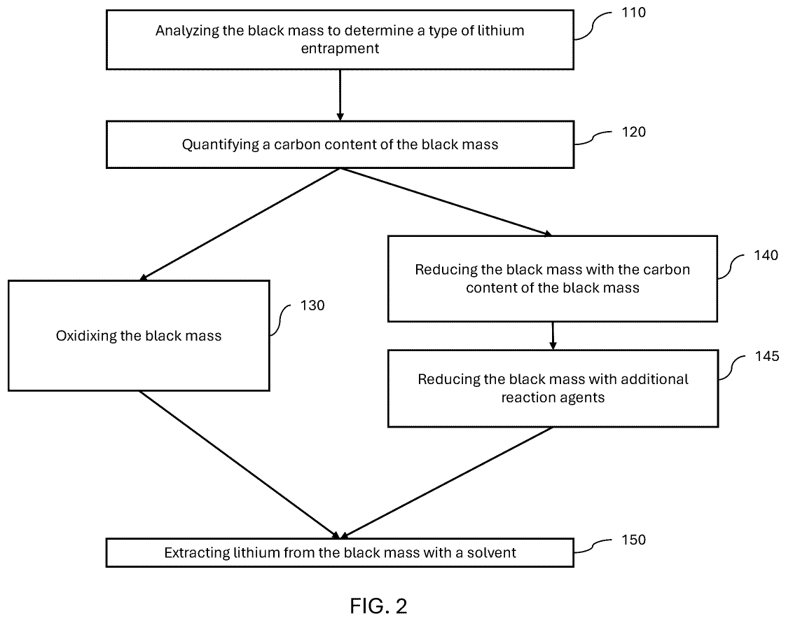

Referring now to FIG. 2, a method of extraction lithium from black mass is shown. Each of the steps will be discussed in more detail below. First, in step 110, the black mass is analyzed to determine the type of lithium entrapment in the black mass. Next, a carbon content of the black mass is quantified, per step 120. If lithium-intercalated graphite is present, the black mass is oxidized (step 130). If lithium-transition metal oxides (Li-TMO) are present, the black mass is reduced, as shown in steps 140 and 145. The oxidation or reduction of steps 130, 140, and 145 is monitored with an oxygen sensor to determine when the reaction is complete. Finally, per step 150, lithium is extracted from the black mass with a solvent.

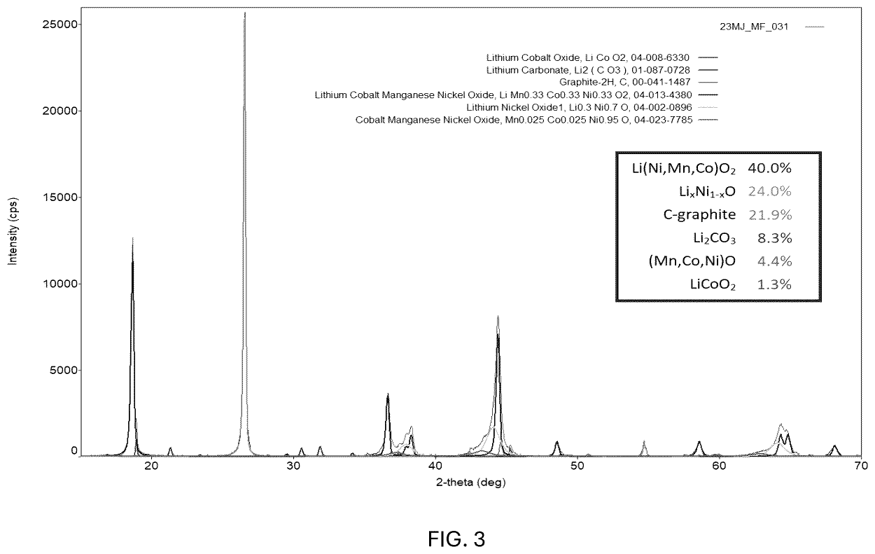

In the analyzation step 110, a batch of black mass is evaluated to determine the type of lithium entrapment. The amounts of various types of components indicates whether oxidation or reduction will most effectively free the trapped lithium. In one form, x-ray diffraction (XRD) is conducted on a sample of the black mass to identify the molecular and/or elemental components. FIG. 3 shows an example of results from XRD on black mass. In this particular example, the black mass sample contains 8.3% soluble Li₂CO₃ and a significant portion of Li-transition metal oxides. Most of the remaining transition metal oxides contain lithium, except for 4.4%. There is about 20% graphite which is not lithium-intercalated. Therefore, the analysis for the sample indicates that a reduction process will be needed to release the lithium (or to convert the lithium reacted with) in the transition metal oxides.

Once the type of lithium entrapment is known, the carbon content of the black mass is quantified (step 120). Knowing the quantity of carbon aids in optimizing subsequent steps. In one form, the carbon is quantified during the x-ray diffraction on a sample of the black mass in the analyzation step, such as in FIG. 3.

In another form, the oxygen sensor is utilized to determine the proportion of carbon in the black mass. In this form, a sample of the black mass is subjected to a heat treatment process in an excess oxygen environment. In certain forms, the instantaneous mass of carbon oxidized is calculated using oxygen sensor data according to the formula:

$$C = \frac{( Δ λ ) \times 0.233 \times \dot{m} \times {δ}_{gas} \times {MW}_{C}}{{MW}_{{O}_{2}}}$$

$$Where : C = Mass of Carbon oxidized ( g / s ) ;$$

$$λ = Lambda reading from oxygen sensor ;$$

$$Δλ = [ {λ}_{in} - {λ}_{out} ] ;$$

$$\dot{m} = Mass flowrate of gas ( L / s ) ;$$

$${δ}_{gas} = Density of gas ( g / L ) ; and$$

$$MW = Molecular weight ( g / mol ) .$$

The carbon portion of the black mass is calculated by dividing the cumulative mass of carbon oxidized while exposing the sample to excess oxygen in the Temperature range from 500° C. to 850° C., and until λᵢₙ=λₒᵤₜ, by the total sample mass. Specifically:

$$Carbon portion of Black Mass = \frac{{\sum }_{T = 500 ° C .}^{850 ° C .} C \times Δ t}{BM}$$

$$Where : Δ t = time increment ( s ) ; and$$

$$BM = Black Mass sample mass ( g ) .$$

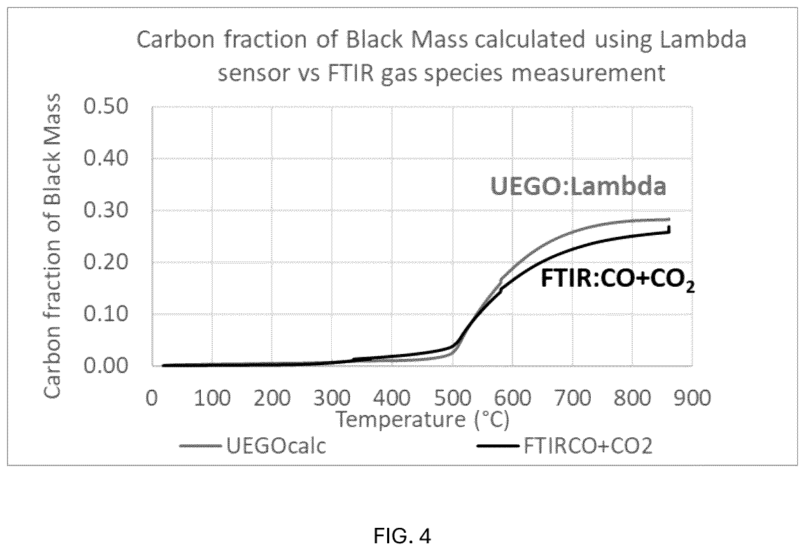

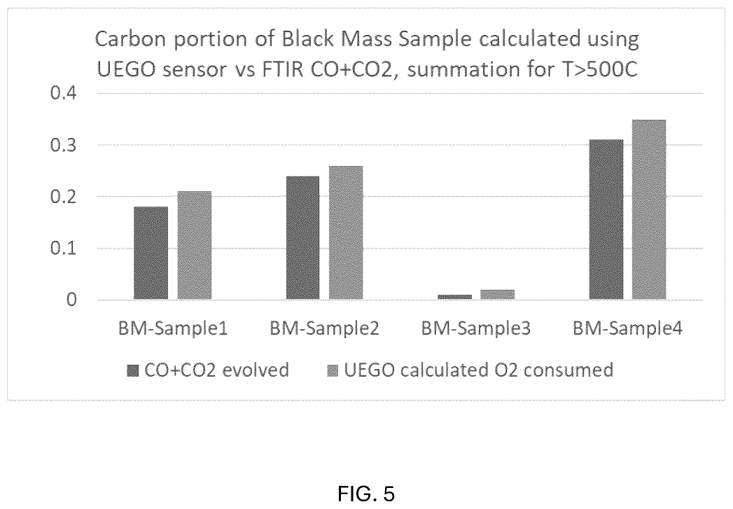

FIGS. 4 and 5 demonstrates that a similar carbon fraction is measured in a sample of Black Mass whether using the UEGO sensor measurement method or a conventional fourier transform infrared (FTIR) analyzer for CO+CO2 analysis.

If the analysis of the black mass indicates lithium-intercalated graphite is present, the black mass is oxidized (step 130). The black mass is reacted with air or excess oxygen (a lean environment). As is oxidizes, the solid graphite matrix breaks down into CO and/or CO₂ and releases the lithium. Carbon oxidation occurs at temperatures great than about 500° C. The oxidation process takes between about 30 minutes and 2 hours, depending on the quantity of carbon and the solid-gas contact area. In one form, the oxidation process takes about 1 hour at about 600° C.

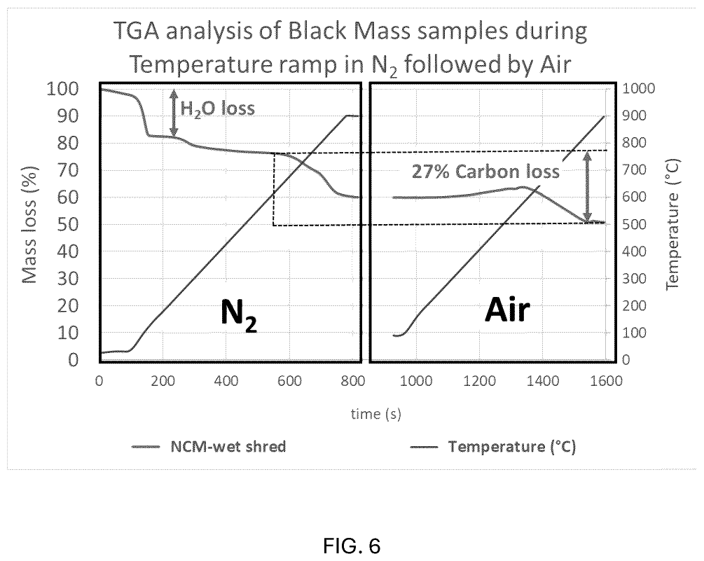

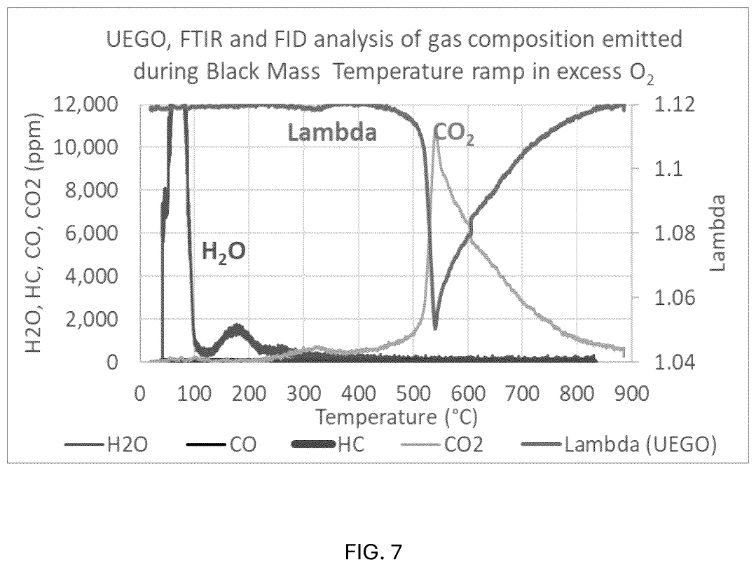

In one form, a temperature ramp-up in a nitrogen and/or air environment may also be performed in which electrolytes remaining in the black mass are volatilized and binders such as PVDF decompose. FIG. 6 shows a temperature ramp in nitrogen followed by air. The sample mass loss at T>600° C. indicates volatilization of reacted or oxidized carbon. In another form, as shown in FIG. 7, the temperature ramp up may be conducted in excess oxygen.

Completion of the oxidation process is monitored by the oxygen sensor. Oxidation is continued until the delta lambda value approaches zero. As discussed, delta lambda value approaches zero when the absolute value of the delta lambda value is less than 0.001. As delta lambda decreases, less oxygen is being consumed by the reaction, indicating that less carbon is available to react. As delta lambda approaches zero, the amount of unreacted carbon is also approaching zero and the amount of oxygen is in the feed and exhaust gas is effectively equal. At that point, most of the entrapped lithium in the graphite has been released.

If the analysis of the black mass indicates the presence of lithium-transition metal oxides, the black mass is reduced (step 140 and step 145). During this process, the lithium contained in or reacted with the transition metal oxides are converted from non-soluble to water-soluble forms. The water-insoluble lithium-transition metal oxides are reduced. New compounds are formed including water-soluble lithium compounds and water-insoluble transition metal compounds, allowing separation of the lithium from the other transition metals. The reduced transition metals become more soluble in acid, but they still do not readily dissolve in water.

In the first reduction step 140, any carbon contained in the black mass is used to reduce the transition metal oxides. Utilizing the carbon reduces the amount of additional reducing agents required to complete the reduction step. The process is monitored with the oxygen monitor as described above. The inlet gas stream is a neutral gas such as nitrogen and therefore the lambda value of the inlet stream is one. Because the furnace heats the black mass to a temperature where carbon reaction with metal oxides is thermodynamically and kinetically favorable, a reducing environment is formed, the lambda value of the exhaust gas is less than one. As the carbon is consumed, the lambda value will approach a target exhaust lambda value. In one form, the target exhaust lambda value is an exhaust lambda value equal to one, indicating a neutral environment with no further reduction occurring. The black mass is reduced with the carbon until the delta lambda value approaches zero. As discussed, delta lambda value approaches zero when the absolute value of the delta lambda value is less than 0.001.

Once the carbon is consumed, additional reducing agents are added to continue the reduction reaction (step 145). Reduction is once again continued until the delta lambda value approaches zero. In one form, the reducing agents include carbon monoxide gas and hydrogen gas. Other gaseous reducing agents which react with the transition metal oxides to release the lithium may also be utilized.

In one form, the black mass is reduced in a nitrogen or other inert environment until the reducing agents are added. In various forms, the reduction steps 140 and 145 may be performed at temperatures of 600° C. or higher, 800° C. or higher, or between 600C and 900° C.

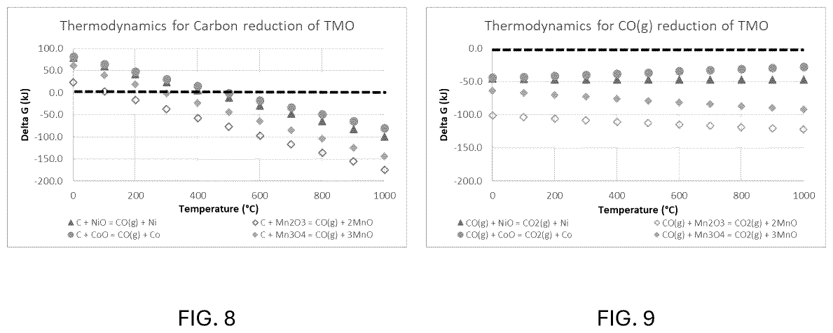

As shown in FIG. 8, the carbon reduction reaction is not thermodynamically favorable at temperatures below 600° C. as indicated by the negative change in Gibbs free energy (delta G). In contrast, FIG. 9 shows that the gas phase reduction reaction is thermodynamically favorable at any temperature.

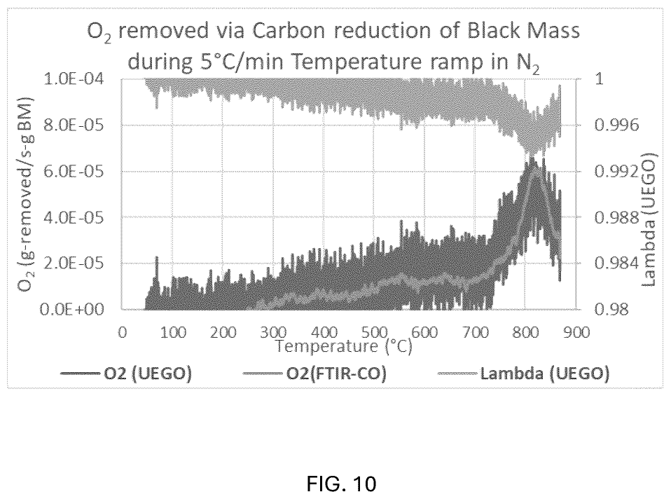

Referring to FIG. 10, below about 550° C., electrolytes and binders are decomposed. As the temperature increases, reduction proceeds slowly until 800° C. when the reaction speeds up. In certain forms, the change in the delta lambda value over time is used to calculate the amount of oxygen removed from the black mass.

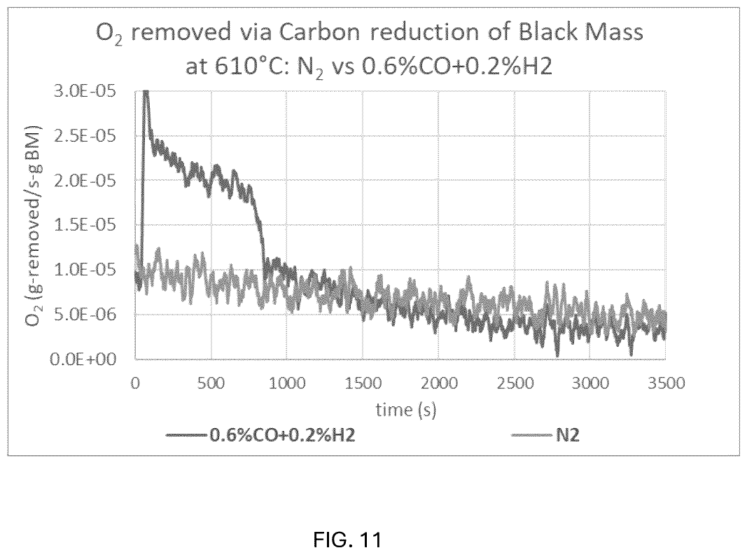

FIG. 11 illustrates the reaction process as reducing agents are added to the black mass. Compared to nitrogen alone, the reduction reaction is faster and more complete.

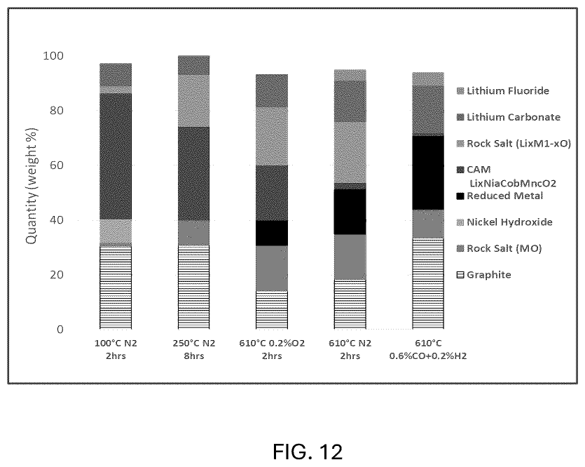

Turning to FIG. 12, the changes in an exemplary black mass composition through the stages of the process is shown. Initially, the black mass contains mainly graphite and non-soluble lithium-transition metal oxides. As the black mass is heated in a nitrogen environment, the graphite is consumed, and the lithium-transition metal oxides begin to be reduced. In the final column, gas phase reagents are introduced, and the amount of non-soluble lithium transition metal oxides drops. The majority of the lithium is now contained in soluble forms.

Finally, the lithium is extracted from the black mass (step 150). By the previous steps, the lithium has been separated from any entrapping matrices and the majority of non-soluble forms of lithium have been converted to soluble forms. Therefore, the lithium can be easily extracted by washing the black mass with a solvent. The solvent is a water-based PH neutral, slightly acidic (pH˜6) or slightly basic solution in which the soluble lithium compounds will readily dissolve but other transition metals will not dissolve at any significant rate in the same solution. In one form, the solvent is de-ionized water. The dissolved lithium can subsequently be separated from the solvent by vacuum filtration, crystallization, precipitation, or other known separation techniques.

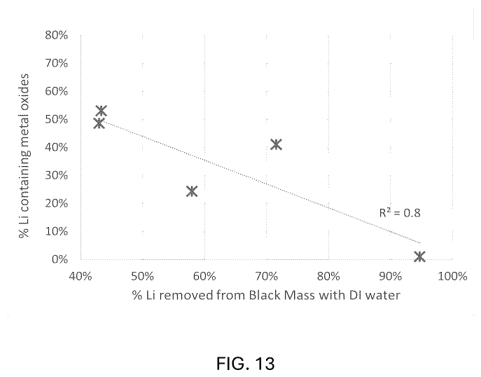

FIG. 13 illustrates that the percentage of lithium which is extracted from black mass increases as the amount of lithium contained in metal oxides decreases. Therefore, a more complete reduction of the black mass is seen to result in increased lithium recovery.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method of extracting lithium from black mass produced by battery recycling, the method comprising:
analyzing the black mass to determine a type of lithium entrapment;
quantifying a carbon content of the black mass in an excess oxygen environment;
adding oxidizing or reducing reagents based on the type of lithium entrapment;
monitoring completion of oxidation or reduction with at least one oxygen sensor, the at least one oxygen sensor providing a delta lambda value; and
extracting lithium from the black mass with a solvent.

2. The method of claim 1, further comprising utilizing the carbon content to reduce transition metal oxides until a target exhaust lambda value is reached.

3. The method of claim 2, wherein the target exhaust lambda value is an exhaust lambda value equal to 1.

4. The method of claim 1, wherein the oxidation or reduction are completed when a delta lambda value approaches 0.

5. The method of claim 1, wherein reduction is performed at a temperature between about 600° C. and 900° C.

6. The method of claim 1, wherein the reducing reagent is at least one of carbon monoxide and hydrogen gas.

7. The method of claim 1, wherein the carbon content is quantified with the at least one oxygen sensor in an environment of excess oxygen.

8. The method of claim 1, wherein the black mass is analyzed by x-ray diffraction.

9. A method of extracting lithium from black mass produced by battery recycling, the method comprising:
analyzing the black mass to determine a type of lithium entrapment;
quantifying a carbon content of the black mass in an excess oxygen environment;
if lithium-intercalated graphite is present, oxidating the black mass with excess oxygen until a delta lambda value approaches 0;
if transition metal oxides are present, utilizing the carbon content to reduce transition metal oxides until a target exhaust lambda value is reached;
adding a reducing reagent to further reduce the transition metal oxides until the delta lambda value approaches 0; and
extracting lithium from the black mass with a solvent.

10. The method of claim 9, wherein the target exhaust lambda value is an exhaust lambda value greater than or equal to 1.

11. The method of claim 9, wherein reduction is performed at a temperature between about 600° C. and 900° C.

12. The method of claim 9, wherein the reducing reagent is at least one of carbon monoxide and hydrogen gas.

13. The method of claim 9, wherein the carbon content is quantified with at least one oxygen sensor in an environment of excess oxygen.

14. The method of claim 9, wherein the black mass is analyzed by x-ray diffraction.

15. The method of claim 9, wherein the delta lambda value is produced by at least one UEGO sensor.

16. A method of extracting lithium from black mass produced by battery recycling, the method comprising:
analyzing the black mass by x-ray diffraction to determine a type of lithium entrapment;
quantifying a carbon content of the black mass in an excess oxygen environment using at least one UEGO sensor;
if lithium-intercalated graphite is present, oxidizing the black mass and monitoring completion of oxidation with the at least one UEGO sensor;
if transition metal oxides are present, reducing transition metal oxides in the black mass and monitoring completion of reduction with the at least one UEGO sensor; and
extracting lithium from the black mass with a solvent.

17. The method of claim 16, wherein a delta lambda value is produced by the at least one UEGO sensor.

18. The method of claim 17, wherein the oxidation is completed when the delta lambda value approaches 0.

19. The method of claim 17, wherein the reduction is completed when the delta lambda value approaches 0.

20. The method of claim 16, wherein a reducing reagent is at least one of carbon, carbon monoxide and hydrogen gas.
